(19) United States
(12) Patent Application Publication
(10) Pub. No.: US 2026/0220162 A1
(43) Pub. Date: Jul. 30, 2026

(54) AUTOMATIC CATEGORY EXTRACTION FOR TAGGING DATA

(71) Applicant: BOLD Limited, Hamilton (BM)

(72) Inventors: Harsh Kumar DEWANGAN, Delhi (IN); Sumanyu ROSHA, Noida (IN); Brajesh KUMAR, Gurgaon (IN); Varun KALIA, Chandigarh (IN)

(21) Appl. No.: 19/041,888

(22) Filed: Jan. 30, 2025

(51) Int. Cl. G06F 16/28

(52) U.S. Cl. CPC G06F 16/285

(57) ABSTRACT

Certain aspects of the disclosure provide a method for extracting candidate categories for tagging data. Certain aspects include receiving, from a data source, untagged data, extracting, from the untagged data, text features, generating a first prompt based on the extracted text features and a list of categories, wherein the first prompt is configured to cause a language model to select one or more candidate categories from the list of categories, sending, to the language model, the first prompt, the job title, and the job responsibilities; receiving, from the language model, the candidate categories, generating a second prompt, wherein the second prompt is configured to cause the language model to select a predetermined number of prioritized categories, sending, to the language model, the second prompt, receiving, from the language model the predetermined number of prioritized categories, and sending, to the data source, the predetermined number of prioritized categories.

### INTRODUCTION

### Technical Field

Aspects of the present disclosure relate to extracting categories for tagging data.

### BACKGROUND

Data entry personnel are frequently tasked with manually reviewing and tagging data with categories or attributes to ensure the data can be effectively searched and accessed. Assigning relevant tags to data or content can facilitates streamlining data retrieval processes and enhancing overall content management. This enables companies to optimize workflows, improve user experiences, and ensure information is categorized accurately for better decision-making and resource utilization. Accordingly, improved techniques for extracting categories for tagging data would be desirable for promoting the aforementioned benefits of effective tagging of untagged data with relevant categories.

### SUMMARY

Certain aspects provide a method including: receiving, from a data source, untagged data; extracting, from the untagged data, text features comprising a job title and job responsibilities; generating a first prompt based on the extracted text features and a list of categories, wherein the first prompt is configured to cause a language model to select one or more candidate categories from the list of categories; sending, to the language model, the first prompt, the job title, and the job responsibilities; receiving, from the language model, the one or more candidate categories selected from the list of categories for tagging the received untagged data; generating a second prompt, wherein the second prompt is configured to cause the language model to select a predetermined number of prioritized categories from the one or more candidate categories; sending, to the language model, the second prompt; receiving, from the language model the predetermined number of prioritized categories; and sending, to the data source, the predetermined number of prioritized categories from the list of categories for tagging the received untagged data.

Other aspects provide a method including: receiving, from a data source, untagged data; extracting, from the untagged data, text features; generating a first prompt based on the extracted text features and a list of categories, wherein the first prompt is configured to cause a language model to select one or more candidate categories from the list of categories; sending, to the language model, the first prompt, the extracted text features, and the list of categories; receiving, from the language model, the one or more candidate categories selected from the list of categories for tagging the received untagged data; generating a second prompt, wherein the second prompt is configured to cause the language model to select a predetermined number of prioritized categories from the one or more candidate categories; sending, to the language model, the second prompt; receiving, from the language model the predetermined number of prioritized categories; and sending, to the data source, the predetermined number of prioritized categories from the list of categories for tagging the received untagged data.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein. The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an illustrative environment for implementing a category extraction system according to one or more aspects shown and described herein.

FIG. 2 depicts illustrative system architecture for implementing a category extraction system according to one or more aspects shown and described herein.

FIG. 3 depicts an illustrative process for extracting categories for tagging data implemented by a category extraction system according to one or more aspects shown and described herein.

FIG. 4 depicts an illustrative process for extracting categories for tagging data implementing a category extraction system according to one or more aspects shown and described herein.

FIG. 5 depicts a method for extracting categories for tagging data, according to one or more aspects shown and described herein.

FIG. 6 depicts an example computing device configured to perform processes of the category extraction system, according to one or more aspects shown and described herein.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for extracting categories for tagging untagged data. Untagged data refers to information or content that lacks metadata or labels that categorize or describe it. Effectively tagging untagged data with highly relevant categories can facilitate searching, retrieving, and organizing based on the tags. Examples of tags for tagging the untagged data may include, but are not limited to, categories, locations, times, user roles, statuses, data sources, topics, and data types. While aspects described herein are generally related to extracting categories for tagging untagged data, it may be understood that systems and methods described herein may be modified to generate prompts for extracting other types of tags for tagging untagged data.

Systems and techniques described herein leverage an application layer and a job queueing layer to pull untagged data from a connected application and schedule jobs to extract relevant categories for tagging the untagged data. As used herein, a “category” refers to a broad grouping or classification that encompasses similar keywords or concepts for organizing untagged data into meaningful segments based on shared characteristics, attributes, or purposes. Systems and methods described herein extract categories by first extracting text features from the untagged data that may be incorporated into processes for generating prompts. Systems and techniques described herein leverage a job processing layer to generate prompts for sending to a language model to cause the language model to assist with determining categories for tagging the untagged data based on extracted text features of the untagged data.

A language model (LM) is generally a type of machine learning model that is designed to understand, generate, and manipulate human language. More specifically, an LM is a probabilistic framework that determines the likelihood of a sequence of words or tokens. At its core, an LM attempts to predict the probability of the next word in a sentence given the preceding words. The model estimates these probabilities based on the patterns it learned during training. LMs are useful in natural language processing (NLP) and computational linguistics for performing a range of tasks involving human language.

LMs may be characterized by various components and capabilities. For example, an LM may include a vocabulary that defines the set of all possible words or tokens that the model can recognize and use. This includes common words, punctuation, and possibly domain-specific jargon. LMs may also consider a context, which refers to the preceding words in a sentence or sequence that the model uses to predict the next word. Modern LMs often incorporate extensive context windows, leveraging entire sentences or even paragraphs.

LMs may be implemented in various ways. For example, N-gram models predict the next word based on the previous N-1 words. Neural network-based LMs include Recurrent Neural Networks (RNNs), Long Short-Term Memory (LSTM) networks, and more Transformer models. These models capture more complex language patterns and context dependencies. The transformer architecture, introduced with models like bidirectional encoder representations and transformers (BERT) and generative pre-training transformers (GPT), utilizes self-attention mechanisms to handle long-range dependencies potentially more effectively than RNNs or LSTMs.

LMs are often trained using large corpora of text. The training process involves adjusting the model's parameters to minimize the difference between its predicted word probabilities and the actual word sequences in the training data. This is typically done via techniques like maximum likelihood estimation and gradient descent.

LMs have a wide array of applications, including: text generation (e.g., producing coherent and contextually appropriate text; machine translation (e.g., converting text from one language to another); speech recognition (e.g., converting spoken language into text); text summarization (e.g., condensing a long piece of text into a shorter summary); sentiment analysis (e.g., determining the sentiment expressed in a piece of text); and question answering (e.g., automatically providing answers to questions posed in natural language).

Thus, a language model is a sophisticated tool in NLP that analyzes and generates human language by understanding the probabilistic relationships between words and leveraging large datasets to learn these relationships. They form the backbone of many modern NLP applications, enabling machines to interpret, generate, and interact with human language.

Current processes for tagging untagged data rely upon manual efforts of data entry personnel. These processes are time-consuming and labor-intensive, requiring individuals to carefully review and assign categories to large volumes of data or content. This can result in increasingly large delays as datasets grow in size over time. Consequently, conventional tagging processes are also error prone, which can lead to downstream processing errors. Current processes of extracting categories for tagging data create a significant risk of human error, with inconsistencies in selection of accurate and relevant categories for tagging due to fatigue, subjective interpretation, or a lack of domain expertise. This creates unwanted variability in quality and precision of extracted categories and assigned tags for untagged data, reducing the overall effectiveness of data categorization efforts. With current approaches, as datasets become more complex and diverse, scaling processes for tagging untagged data becomes increasingly difficult, requiring more data entry personnel to complete a task, increasing resource expenditure.

In contrast, aspects described herein provide a technical solution to the shortcomings of current approaches by leveraging processing systems including a novel system architecture that is configured to capture untagged data, extract text features of the untagged data, and generate prompts for causing a language model to precisely predict relevant categories for tagging in a way that is efficient and scalable with increasingly large datasets. By leveraging generated prompts configured for causing language models to generate candidate categories for tagging the untagged data, aspects described herein significantly speeding up the process of extracting categories for tagging, and removing the need for time-consuming, labor-intensive, and error-prone efforts by having data entry personnel manually selecting relevant categories. Certain aspects may be configured to provide a predetermined number of prioritized categories that may be adjusted to obtain additional or fewer options for prioritized categories with which to tag the untagged data. In certain aspects, the prioritized categories, returned to the data source by system and methods described herein, may enable a data entry specialist to quickly review and apply selected categories of the prioritized categories to tag the untagged data. In some aspects, the prioritized categories returned to the data source may be utilized by the data source (such as an application) to automatically tag the untagged data using the prioritized categories. Aspects described herein further provide technical solutions for leveraging computing devices configured to generate prompts configured to cause language models to accurately and precisely determine relevant categories for tagging received untagged data, enhancing established relationships by uncovering new connections within the data. The generated prompts further include a list of categories to allow the language model to effectively detect relevant keywords and associate them with pertinent job categories from the provided list of categories, enabling precise extraction, grounded in specific information, thereby enhancing accuracy in categorization and avoiding the unwanted variability associated with category extraction for tagging data.

Accordingly, aspects described herein provide technical solutions for addressing shortcomings of conventional techniques. Aspects described further provide technical benefits such as enhancing workflow efficiency for tagging data by automating extraction of untagged data from an application, queuing jobs for generating categories for the untagged data, and generating prompts configured to cause a language model to generate candidate tags for returning to the application. This provides the technical benefit of enhanced workflow efficiency by automating features to reduce processing time of processes for tagging untagged data. Aspects described herein further provide for generating improved contextually relevant tags by utilizing generated prompts to leverage language models for producing more accurate and meaningful tags, thereby providing for the technical benefit of improved classification accuracy and improved relevance in downstream tasks such as searching, filtering, or categorization. Aspects described herein further provide the technical benefit of improved scalability by enabling queuing of high volumes of jobs for extracting and generating categories for tagging untagged data, ensuring consistent performance and allowing the system to distribute processing load (without overloading described systems or employed language models) over time to handle transient spikes in data input. The aforementioned technical benefits provided by aspects described herein are merely illustrative. Additional technical benefits may be better understood in view of the illustrative aspects described below.

### Example Category Extraction Systems and Techniques

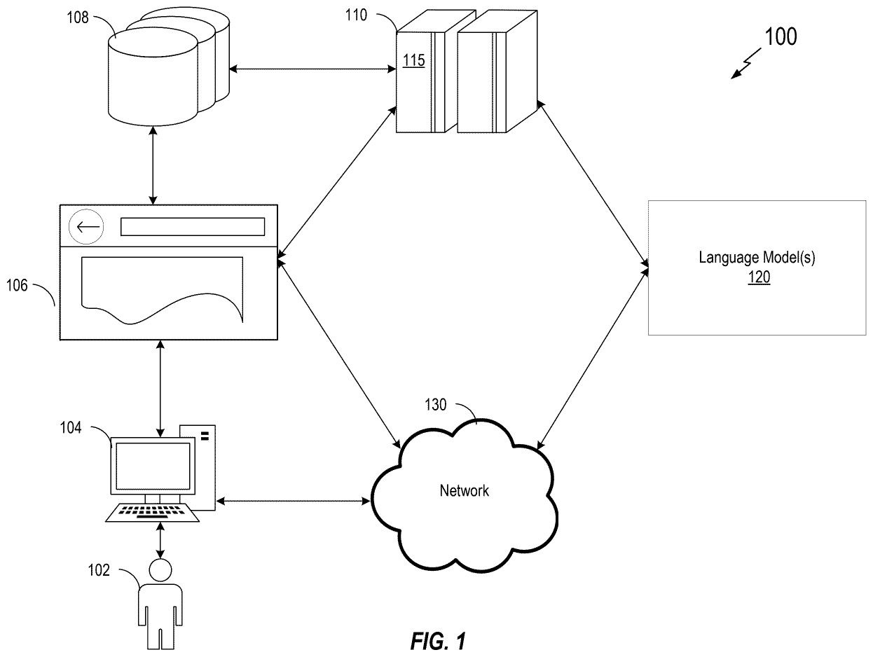

FIG. 1 depicts an illustrative environment 100 for implementing a category extraction system 110 according to one or more aspects shown and described herein. A user 102 may interface with aspects of category extraction system 110, for example implemented by one or more computing devices, through a device 104. In certain aspects, device 104 may be a personal computer, a tablet computer, a smart device (e.g., a smartphone), or the like. In certain aspects, user 102 may be a data entry technician or an administrator. User 102 may leverage device 104 to interact with an application 106 containing untagged data therein. As an example, application 106 may be a job services platform including untagged job descriptions or job postings. In certain aspects, untagged data may refer to any type of taggable data including textual content, documents, presentations, transactional data, user data, logs and systems data, metadata, or other types of taggable data. As previously discussed, untagged data may be tagged using a variety of features useful for organizing and labeling the untagged data. Examples of tags for tagging the untagged data may include, but are not limited to, categories, locations, times, user roles, statuses, data sources, topics, and data types. While aspects described herein are generally related to extracting categories for tagging untagged data based on extracted text features from the untagged data, it is understood that systems and methods described herein may be modified to generate prompts for extracting other types of tags for tagging the untagged data.

Device 104 includes a display device for implementing a user interface of application 106 with the respective user, one or more processors for executing logic and one or more non-transitory computer-readable mediums for storing information and/or computer readable instructions. Device 104 may access application 106 via a network 130, which may be a wide area network (WAN), such as the Internet, a local area network (LAN), or any other type of network connection, including a connection that spans multiple networks.

In certain aspects, category extraction system 110 is configured to communicate with application 106 to perform illustrative methods to capture untagged data, extract text features from the untagged data, and generate prompts for sending to language model(s) 120. In some aspects, language model 120 is utilized using application programming interface calls. However, in some aspects, language model 120 may be installed and hosted locally to be utilized by category extraction system 110.

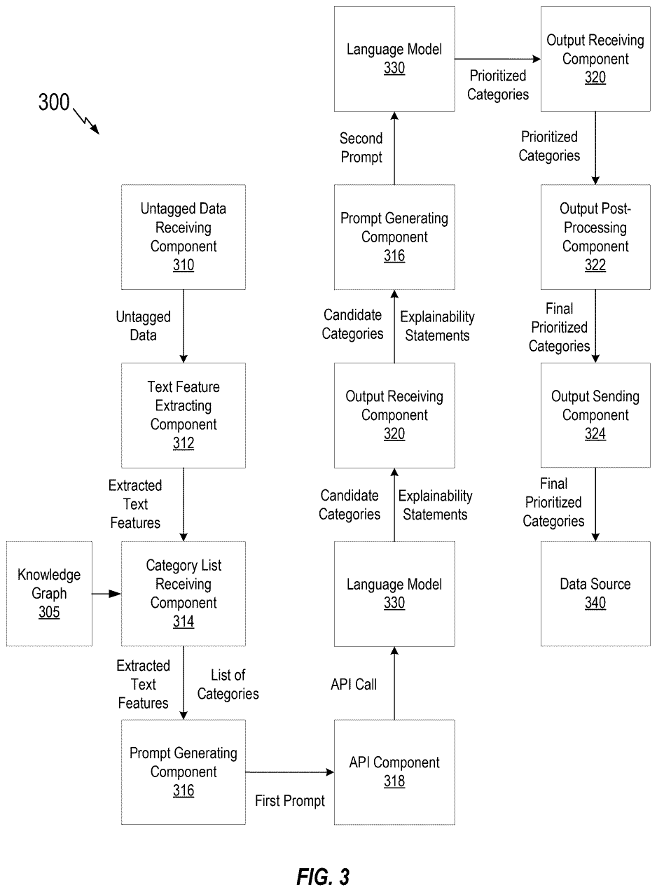

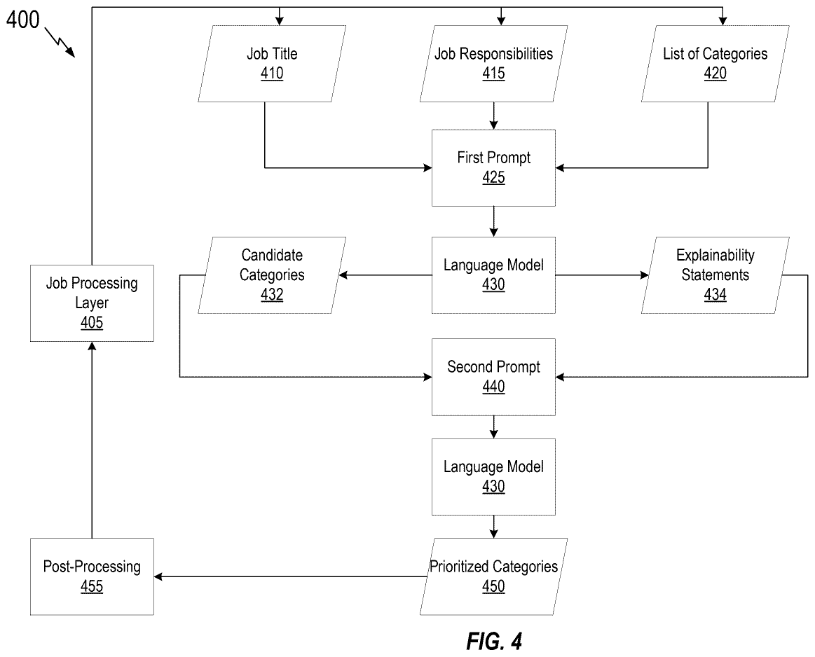

In certain aspects, category extraction system 110 utilizes a prompt generating component configured to utilize one or more stored prompt templates specifically tailored to cause a language model to generate a predetermined number of prioritized categories for tagging data based on extracted text features of the untagged data. As an example, a given prompt template utilized by category extraction system 110 may include fixed components and placeholders for certain variables that may be filled with specific extracted text features related to the untagged data. Alternatively, the placeholders for certain variables may be filled with a list of categories for the language model to consider based on a relevant domain or knowledge graph associated with the data source, such as the application from which the untagged data is received. In some aspects, the generated prompts include a first prompt configured to cause the language model(s) 120 to generate candidate categories, and a second prompt configured to cause the language model(s) 120 to further select a predetermined number of prioritized categories for tagging the untagged data. Category extraction system 110 may receive, from language model(s) 120, the selected predetermined number of prioritized categories for tagging the untagged data, and send it back to the application 106 for displaying to the user. In certain aspects, the prioritized categories, returned to the application 106 by system and methods described herein, may enable a data entry specialist to quickly review and apply selected categories of the prioritized categories to tag the untagged data. In some aspects, the prioritized categories returned to the application 106 may be utilized by application 106 to automatically tag the untagged data using the prioritized categories. Illustrative methods performable by category extraction system 110 are described in greater detail below in connection with FIGS. 3-4.

In certain aspects, category extraction system 110 includes one or more computing devices 115 including one or more processors and one or more non-transitory computer-readable mediums storing computer readable instructions that, when executed by the one or more processors, cause the one or more computing devices to perform processes defined by computer-readable instructions corresponding to one or more components depicted and described herein.

In certain aspects, the language model(s) 120 include one or more artificial intelligence-based machine learning models including, but not limited to language models such as OpenAI's ChatGPT, NeMOTM LLM from NVIDIA®, LLaMa from Meta®, BERT from Google®, CLAUDE™ from Anthropic A.I., and FLAN-T5 form Google®. Components of the processes described herein can implement one or more language models currently developed or that may be developed in the future.

In certain aspects, to perform processes described herein, category extraction system 110 is further configured to store the predetermined number of prioritized categories and associated reasoning and rationale data into an accessible database 108. Accessible database 108 may further be configured to communicate with and be accessed by application 106 to leverage the stored data for future tasks.

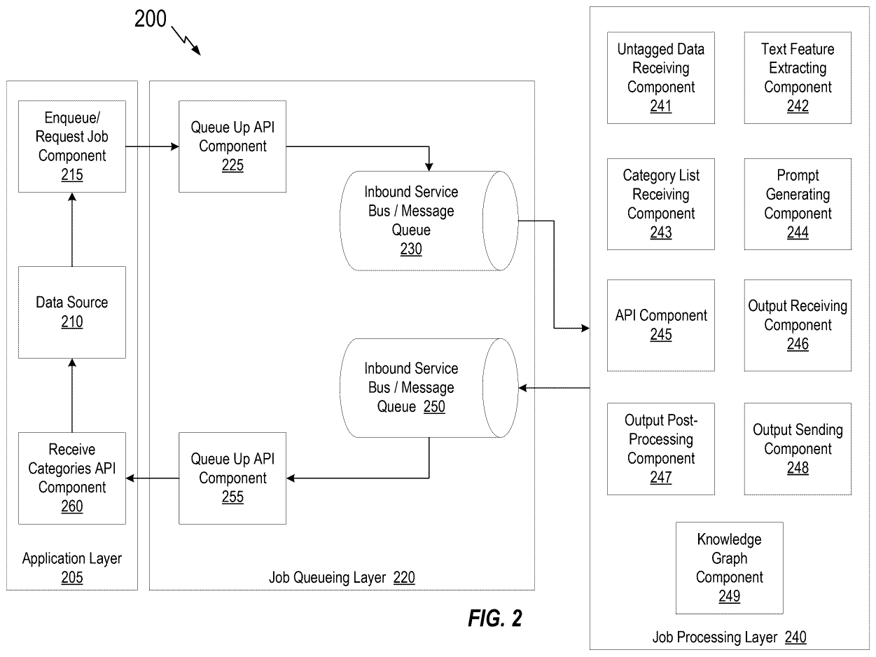

FIG. 2 depicts illustrative system architecture 200 for implementing a category extraction system 110 according to one or more aspects shown and described herein.

Illustrative system architecture 200 includes an application layer 205, a job queueing layer 220, and a job processing layer 240. As used herein, a “layer” refers to architecture of systems described herein that organize related functionalities and responsibilities performed by a set of one or more components making up a given layer.

The application layer 205 of category extraction system 110 is used to capture untagged data from an application employing category extraction system 110. Application layer 205 includes a data source 210 for sourcing data from a connected application, a request job component 215 for sending job requests to extract categories for untagged data to a downstream component, and a receive categories application programming interface (API) component 260 for receiving prioritized categories to return back into the application, which in some aspects includes a predetermined number of prioritized categories.

The job queueing layer 220 of category extraction system 110 includes a queue up API component 225 for receiving the requested jobs from request job component 215 and moving them into a queue of jobs. The queue of jobs may then be passed through an inbound service bus and/or message queue 230. The inbound service bus and/or message queue 230 may then send the queued up jobs to job processing layer 240.

The job queueing layer 220 may further include a second inbound service bus and/or message queue 250 for sending a message containing the predetermined number of prioritized categories (received from the language model) to a second queue up API component 255. Second queue up API component 255 is configured to send the message into a queue of messages to be received by the receive categories API component 260 of application layer 205, thereby returning the extracted categories (the predetermined number of prioritized categories) for the untagged data back to the application from which it was sourced.

The job processing layer 240 includes an untagged data receiving component 241, a text feature extracting component 242, a category list receiving component 243, a prompt generating component 244, an API component 245, an output receiving component 246, an output post-processing component 247, an output sending component 248, and a knowledge graph component 249. The components of job processing layer 240 will be described in greater detail below.

FIG. 3 depicts an illustrative process 300 for extracting categories for tagging data implemented by a category extraction system according to one or more aspects shown and described herein. More specifically, illustrative process 300 demonstrates how job a job processing layer (such as job processing layer 240 of FIG. 2) of a category extraction system according to aspects described herein processes a received job to extract categories for untagged data. As shown, illustrative process 300 begins with an untagged data receiving component 310 sending received untagged data (e.g. received from a job queueing layer, such as job queueing layer 220 of FIG. 2) to a text feature extracting component 312. In certain aspects, text feature extracting component 312 is configured to extract any text features that may be useful for generating a prompt to send to a language model for generating candidate categories. In some aspects, extractable text features include descriptions, keywords and key phrases, named entities (e.g. people, organizations, locations, dates, etc.) or any other extractable text features as may be useful for extracting candidate categories for tagging the untagged data. As an example, category extraction system 110 may utilize text feature extracting component 312 to extract job responsibilities and job titles from untagged data including untagged job descriptions.

Illustrative process 300 proceeds with a category list receiving component 314 receiving a list of categories that may be incorporated into generated prompts to enhance the precision and accuracy downstream candidate generation by a language model. In some aspects, the list of categories may be derived from a knowledge graph 305.

Illustrative process 300 proceeds with a prompt generating component 316 of the category extraction system leveraging the extracted text features and the list of categories for the untagged data to generate a prompt. In certain aspects, prompt generating component 316 leverages the extracted text features and the list of categories to generate a prompt configured to cause a language model 330 to generate a set of candidate categories based on the extracted text features and the list of categories. The extracted text features and the list of categories provide context usable by prompt generating component to generate a prompt configured for causing a language model to generate highly accurate and relevant candidate categories for tagging. For example, prompt generating component 316 may utilize a prompt template having a first portion for including extracted text features, and a second portion for receiving a list of categories for consideration by the language model. It may be appreciated that category extraction system 110 being configured to generate prompts for producing more accurate and meaningful extracted candidate categories for tagging the untagged data provides a technical benefit of improved classification accuracy during tagging of the untagged data and improved relevance in downstream tasks such as searching, filtering, or categorization.

An API component 318 of category extraction system 110 then performs an API call to send the generated prompt to a language model 330.

Illustrative process 300 proceeds with language model 330 executing the prompt to generate a set of candidate categories for the untagged data. As an example, the language model 330 may execute a generated first prompt for an untagged document, causing the language model to generate a set of 30 candidate categories based on a received list of 100 categories. In certain aspects, the number of candidate categories in the generated set of candidate categories may increase or decrease based on how many of the categories in the list of categories are correlated with the extracted text features (as determined by the language model 330) of the untagged data. In certain aspects, language model 330 further generates explainability statements including reasoning and/or rationales for each generated candidate category. As an example, the language model may generate a candidate category “Remote” for an untagged job description, with a corresponding explainability statement indicating that “The provided text includes specific phrases indicating that the position allows flexibility in the work location, such as “work from anywhere,” and “remote-friendly environment.” In certain aspects, language model 330 then sends the generated candidate categories and the corresponding explainability statements to an output receiving component 320 of category extraction system 110.

Illustrative process 300 proceeds with prompt generating component 316 of category extraction system 110 generating a second prompt configured to cause the language model 330 to narrow the list of candidate categories for the untagged data to a predetermined number of prioritized categories that have the strongest correlation to the extracted text features of the untagged data. This will cause the language model 330 to generate a shorter list of most relevant categories that may be most suitable for tagging the untagged data. Language model 330 then processes the second prompt to generate the predetermined number of prioritized categories for the untagged data. The language model 330 then sends the predetermined number of prioritized categories as output to an output post-processing component 322 of category extraction system 110. In some aspects, language model 330 may generate unexpected categories not included in the provided list of categories. Because language models are trained on vast amounts of data, the language model may recognize patterns and suggest categories based on the language model's knowledge of relevant data, causing the language model to suggest more relevant categories even if they fall outside of the list of categories provided within the generated prompt. In certain aspects, the generated categories not included in the provided list of categories may include hallucinations of the language model. As used herein, “hallucinations” may refer to any instance where the language model generates information not grounded in the input, facts, or provided data. Accordingly, in some aspects, output post-processing component 322 is configured to detect extraneous categories not included in the list of categories, and remove them from the predetermined number of prioritized categories for the untagged data. This provides the convenience of ensuring that the predetermined number of prioritized categories only includes categories for tagging that are suitable for and recognizable by the application from which the untagged data is sourced. This may be particularly important for aspects in which the application is configured to automatically tag the untagged data using the predetermined number of prioritized categories.

The output post-processing component 322 then sends the final prioritized categories for the untagged data to an output sending component 324. The output sending component 324 is configured to return the final prioritized categories for the untagged data back to a data source 340 (for example via job queueing layer 220 of FIG. 2) for tagging.

It may be appreciated that category extraction system 110 is configured to perform processes for extracting categories for untagged data that provide a technical benefit of enhancing workflow efficiency for tagging data by automating various features (e.g. extraction of untagged data from an application, queuing jobs for generating categories for the untagged data, generating specialized prompts to cause a language model to generate candidate tags for returning to the application, etc.). This provides the technical benefit of enhancing workflow efficiency by automating features to reduce processing time of employed techniques for extracting and generating categories for tagging received untagged data.

FIG. 4 depicts an illustrative process 400 for extracting categories for tagging data by implementing a category extraction system according to one or more aspects shown and described herein. More specifically, illustrative process 400 depicts how a job processing layer 405 of a category extraction system 110 is used to generate a first and a second specialized prompt for causing a language model 430 to assist in precisely and efficiently generating categories for received untagged job descriptions. Certain aspects of illustrative process 400 are similar to those described above in connection with illustrative process 300 of FIG. 3. Accordingly, certain steps related to receiving the untagged

In illustrative process 400, job processing layer 405 of category extraction system 110 executes a job to generate categories for tagging an untagged job description originally received from a data source. Category extraction system 110 first extracts (for example using text feature extracting component 242 of FIG. 2) from the untagged job description, a job title 410 and job responsibilities 415. In certain aspects, the job responsibilities includes natural language text detailing various features (e.g. expected tasks to be performed, experience requirements, job type, travel expectations, etc.) of the untagged job description. Category extraction system 110 then leverages job title 410, job responsibilities 415, and a list of categories 420 to generate a first prompt 425 (for example using the prompt generating component 244 of FIG. 2) for sending to a language model 430. As previously discussed, the first generated prompt may be based on a first prompt template that is then modified to include the job titles 410, job responsibilities 415, and the list of categories 420 as specific variables to be considered by the language model.

As discussed above, language model 430 then executes the first prompt to generate a set of candidate categories 432 and corresponding explainability statements 434. Category extraction system 110 then leverages the candidate categories and the explainability statements to generate a second prompt 440 for sending to the language model 430. In certain aspects, the candidate extraction system may be further configured to return the explainability statements back to the application (the data source) from which the untagged data was received. The explainability statements may subsequently be stored within an accessible database for the benefit of a user or company employing systems and methods described herein to generate candidate categories for tagging untagged data. Language model 430 executes the second prompt 440 to distill the set of candidate categories to a predetermined number of prioritized categories 450. The predetermined number of prioritized categories generated by the language model 430 may be indicated within the second generated prompt as a fixed value from the prompt template. As an example, a list of categories including 200 categories may cause a language model to generate a first set of categories including 30 categories. The first set of 30 categories may include, for example, 30 categories which language model 430 has determined are relevant for the purposes of tagging the untagged data. However, 30 categories is often impractical for purposes of tagging untagged data, as increasing the number of tagged categories dilutes the relevance of individual tags, and results in decreased precision in searching and filtering due to a broad array of categories associated with the tagged data. Accordingly, category extraction systems described herein then generate a second prompt to cause language model 430 to generate, for example, 5 prioritized categories most suitable for tagging the received untagged job description.

In certain aspects, systems and methods described herein may be configured to leverage a single prompt to generate the predetermined number of prioritized categories based on the extracted text features and the provided list of categories using a condensed process. However, in some aspects, generating two separate prompts allows for separation of concerns, enabling the employed language model to focus on one objective at a time (e.g. first generating a list of candidate categories based on the provided list of categories, and then distilling that list down to a predetermined number of prioritized categories that are most relevant) when processing provided prompts. This also prevents the risk of the language model prematurely discarding candidate categories it may have had the freedom to consider if performing a first prompt to consider a broader set of candidate categories. Furthermore, in certain aspects, having a first and a second prompt may allow flexibility in modifying the prompt templates or instructions provided to the prompt generating component, such that the second prompt may be configured to distill the candidate categories into the predetermined number of prioritized categories based on specific criteria. This allows a user of systems described herein flexibility to leverage the first generated list of candidate categories for different types of tagging objectives.

In certain aspects, as discussed above, systems and methods described herein may cause a language model to generate explainability statements. By generating two separate prompts, systems and methods described herein provide greater flexibility for a company or user to obtain and store additional explainability and reasoning data (for example within the accessible database 108 previously described in FIG. 1) that may be valuable to the user or company for other tasks.

Language model 430 then sends, as previously discussed, the predetermined number of prioritized categories back to category extraction system 110 for post-processing 455 to remove any extraneous prioritized categories not included in the list of categories. A final set of prioritized categories, having been post-processed, is then sent back to the job processing layer for sending (for example using output sending component 248 of FIG. 2) back to job queueing layer 220 for returning the prioritized categories, for tagging the untagged job description, back to the application (data source) from which it was sourced.

It may be appreciated that the described illustrative processes performable by category extraction system 110 provide the technical benefit of improved scalability for handling high volumes of jobs for extracting and generating categories for tagging untagged data, ensuring consistent performance and allowing the system to distribute processing load (without overloading described systems or employed language models) over time to handle transient spikes in data input. Illustrative process 400 is merely illustrative, and other examples of extractable text features may be used by category extraction system 110 to generate specialized prompts including context and other text features as may be useful for causing a language model to generate candidate categories for tagging different types of untagged data.

### Example Method for Extracting Categories for Tagging Data

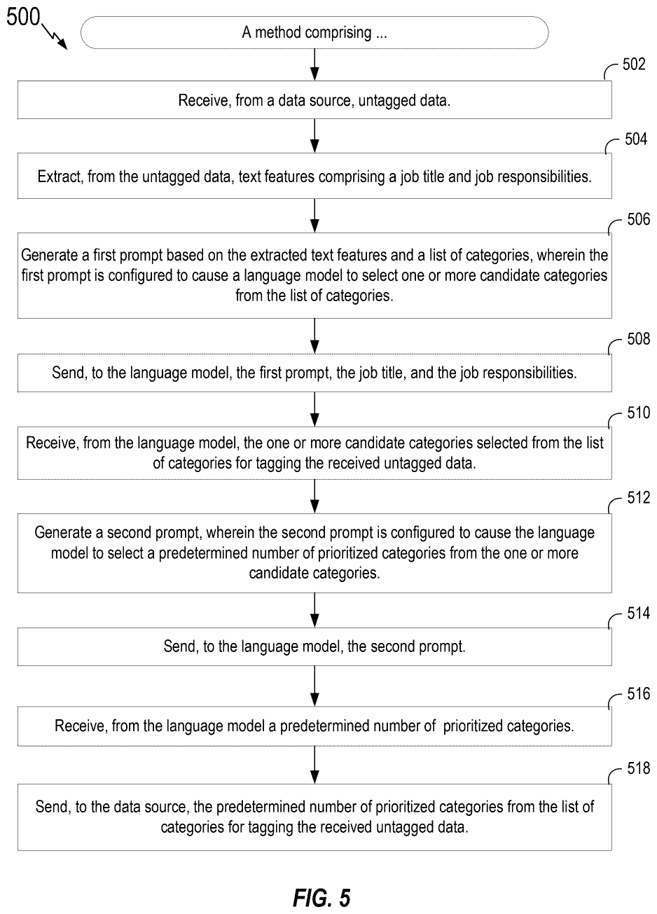

FIG. 5 depicts an example flow diagram of a method 500 for extracting candidate categories for tagging data according to one or more aspects shown and described herein:

In this example, method 500 begins at block 502 with receiving, from a data source, untagged data. For example, the receiving may be performed by one or more computing devices of a category extraction system in accordance with aspects described herein, such as computing devices 115 of category extraction system 110, described above with reference to FIG. 1, configured to implement components such as the untagged data receiving component 241 of FIG. 2.

Method 500 then proceeds to block 504 with extracting, from the untagged data, text features comprising a job title and job responsibilities. For example, the extracting may be performed by one or more computing devices of category a extraction system in accordance with aspects described herein (such as computing devices 115 of category extraction system 110 described above with reference to FIG. 1) configured to implement components such as the text feature extracting component 242 of FIG. 2.

Method 500 then proceeds to block 506 with generating a first prompt based on the extracted text features and a list of categories, wherein the first prompt is configured to cause the language model to select one or more candidate categories from the list of categories. For example, the generating may be performed by one or more computing devices of category a extraction system in accordance with aspects described herein (such as computing devices 115 of category extraction system 110 described above with reference to FIG. 1) configured to implement components such as the prompt generating component 244 of FIG. 2.

Method 500 then proceeds to block 508 with sending, to a language model, the first prompt, the job title, and the job responsibilities. For example, the sending may be performed by one or more computing devices of category a extraction system in accordance with aspects described herein (such as computing devices 115 of category extraction system 110 described above with reference to FIG. 1) configured to implement components such as the API component 245 of FIG. 2.

Method 500 then proceeds to block 510 with receiving, from the language model, the one or more candidate categories selected from the list of categories for tagging the received untagged data. For example, the receiving may be performed by one or more computing devices of category a extraction system in accordance with aspects described herein (such as computing devices 115 of category extraction system 110, described above with reference to FIG. 1) configured to implement components such as the API component 245 of FIG. 2.

Method 500 then proceeds to block 512 with generating a second prompt, wherein the second prompt is configured to cause the language model to select a predetermined number of prioritized categories from the one or more candidate categories. For example, the generating may be performed by one or more computing devices of category a extraction system in accordance with aspects described herein (such as computing devices 115 of category extraction system 110, described above with reference to FIG. 1) configured to implement components such as the prompt generating component 244 of FIG. 2

Method 500 then proceeds to block 514 with sending, to the language model, the second prompt. For example, the sending may be performed by one or more computing devices of category a extraction system in accordance with aspects described herein (such as computing devices 115 of category extraction system 110, described above with reference to FIG. 1) configured to implement components such as the API component 245 of FIG. 2

Method 500 then proceeds to block 516 with receiving, from the language model the predetermined number of prioritized categories. For example, the receiving may be performed by one or more computing devices of category a extraction system in accordance with aspects described herein (such as computing devices 115 of category extraction system 110, described above with reference to FIG. 1) configured to implement components such as the API component 245 of FIG. 2.

Method 500 then proceeds to block 518 with sending, to the data source, the predetermined number of prioritized categories from the list of categories for tagging the received untagged data. For example, the receiving may be performed by one or more computing devices of category a extraction system in accordance with aspects described herein (such as computing devices 115 of category extraction system 110, described above with reference to FIG. 1) configured to implement components such as the output sending component 248, the second inbound service bus and/or message queue 250, the queue up API component 255 and the receive categories API component of FIG. 2.

In certain aspect, method 500 may further include requesting, via an application programming Interface (API), to add a job to an inbound message queue, wherein the job comprises generating the selected categories for the received untagged data; and sending, from an inbound service bus comprising the inbound message queue, the job to a job processing layer. In certain aspects, the list of categories is derived from a knowledge graph associated with a domain of the data source. In certain aspects, the first prompt and the second prompt are sent to the language model via an application programming interface.

In certain aspects, method 500 further includes detecting, within the predetermined number of prioritized categories, one or more extraneous categories by cross-referencing the predetermined number of prioritized categories with the list of categories; and removing the one or more extraneous categories from the predetermined number of prioritized categories.

In certain aspects, method 500 further includes sending, to an inbound message queue, the predetermined number of prioritized categories; sending, via a first application programming Interface (API), a request to add a message comprising the predetermined number of prioritized categories to a queue of data to be received by the data source; and receiving, at the data source, via a second API, the message comprising the predetermined number of prioritized categories.

In certain aspects, method 500 further includes receiving, from the language model, explainability statements associated with respective candidate categories of the generated candidate categories; and sending the explainability statements to the data source.

### Example Category Extraction Computing Device

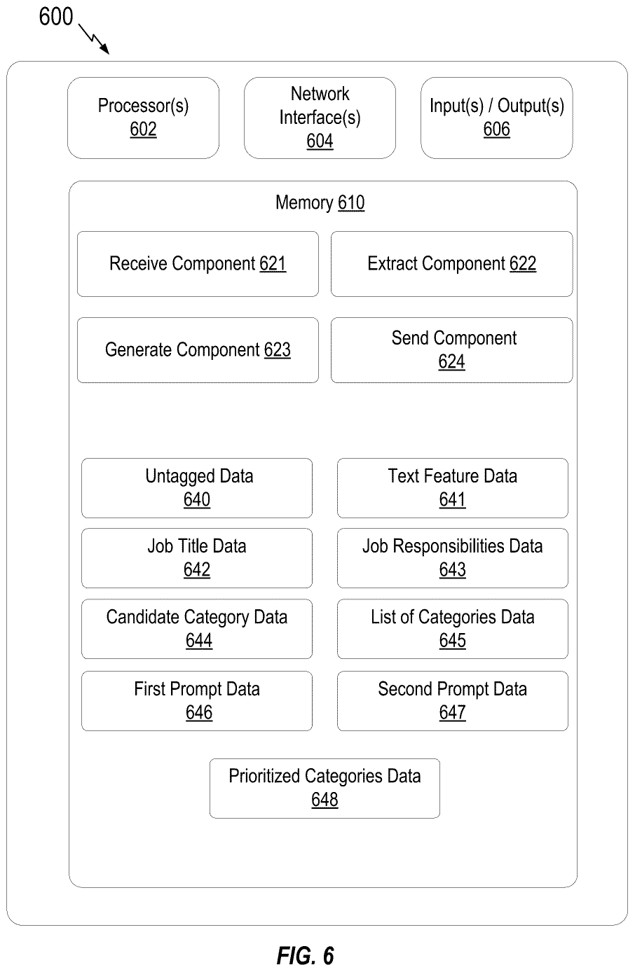

FIG. 6 schematically depicts an example computing device 600 for enabling a category extraction system for tagging data according to one or more aspects shown and described herein.

The computing device 600 includes one or more processors 602. Generally, processor(s) 602 may be configured to execute computer-executable instructions (e.g., software code) to perform various functions, as described herein.

The computing device 600 further includes a network interface(s) 604, which generally provides data access to any sort of data network, including personal area networks (PANs), local area networks (LANs), wide area networks (WANs), the Internet, and the like.

The computing device 600 further includes input(s) and output(s) 606, which generally provide means for providing data to and from the computing device 600, such as via connection to computing device peripherals, including user interface peripherals.

The computing device 600 further includes a memory 610 configured to store various types of components and data.

In this example, memory 610 includes a receive component 621, an extract component 622, a generate component 623, and a send component 624.

Receive component 621 may be configured to perform processes, for example, corresponding to blocks 502, 510, and 516 of method 500 depicted and described with reference to FIG. 5.

Extract component 622 may be configured to perform processes, for example, corresponding to block 504 of the method 500 depicted and described with reference to FIG. 5.

Generate component 623 may be configured to perform processes, for example, corresponding to blocks 506 and 512, of method 500 depicted and described with reference to FIG. 5.

Send component 624 may be configured to perform processes, for example, corresponding to blocks 508, 514, and 518 of method 500 depicted and described with reference to FIG. 5.

In this example, memory 610 also includes untagged data 640, text feature data 641, job title data 642, job responsibility data 643, candidate category data 644, list of categories data 645, first prompt data 646, second prompt data 647, and prioritized categories data 648.

The computing device 600 may be implemented in various ways. For example, the computing device 600 may be implemented within on-site, remote, or cloud-based computing devices.

The computing device 600 is just one example, and other configurations are possible. For example, in alternative aspects, aspects described with respect to the computing device 600 may be omitted, added, or substituted for alternative aspects.

Aspects described herein provide a technical solution to the shortcomings of current approaches by leveraging processing systems including a novel system architecture that is configured to capture untagged data, extract text features of the untagged data, and generate prompts for causing a language model to precisely predict relevant categories for tagging in a way that is efficient and scalable with increasingly large datasets. Aspects described herein further provide technical benefits such as enhancing workflow efficiency for tagging data by automating extraction of untagged data from an application, queuing jobs for generating categories for the untagged data, and generating prompts configured to cause a language model to generate candidate tags for returning to the application. This provides the technical benefit of enhanced workflow efficiency by automating features to reduce processing time of processes for tagging untagged data. Aspects described herein further provide for generating improved contextually relevant tags by utilizing generated prompts to leverage language models for producing more accurate and meaningful tags, thereby providing for the technical benefit of improved classification accuracy and improved relevance in downstream tasks such as searching, filtering, or categorization. Aspects described herein further provide the technical benefit of improved scalability by enabling queuing of high volumes of jobs for extracting and generating categories for tagging untagged data, ensuring consistent performance and allowing the system to distribute processing load (without overloading described systems or employed language models) over time to handle transient spikes in data input.

### EXAMPLE CLAUSES

Clause 1: A method including receiving, from a data source, untagged data; extracting, from the untagged data, text features comprising a job title and job responsibilities; generating a first prompt based on the extracted text features and a list of categories, wherein the first prompt is configured to cause the language model to select one or more candidate categories from the list of categories; sending, to a language model, the first prompt, the job title, and the job responsibilities; receiving, from the language model, the candidate categories selected from the list of categories for tagging the received untagged data; generating a second prompt based on the candidate categories; sending, to the language model, the second prompt; receiving, from the language model a predetermined number of prioritized categories; and sending, to the data source, the predetermined number of prioritized categories from the list of categories for tagging the received untagged data.

Clause 2: The method of Clause 1, wherein the list of categories is derived from a knowledge graph associated with a domain of the data source.

Clause 3: The method of Clause 2, further including requesting, via an application programming Interface (API), to add a job to an inbound message queue, wherein the job comprises generating the selected categories for the received untagged data; and sending, from an inbound service bus comprising the inbound message queue, the job to a job processing layer.

Clause 4: The method of any one of Clauses 1-3, wherein the first prompt and the second prompt are sent to the language model via an application programming interface.

Clause 5: The method of any of Clauses 1-4, further including detecting, within the predetermined number of prioritized categories, one or more extraneous categories by cross-referencing the predetermined number of prioritized categories with the list of categories; and removing the one or more extraneous categories from the predetermined number of prioritized categories.

Clause 6: The method of any of Clauses 1-5, wherein sending, to the data source, the predetermined number of prioritized categories from the list of categories for tagging the received untagged data further includes: sending, to an inbound message queue, the predetermined number of prioritized categories; sending, via a first application programming Interface (API), a request to add a message comprising the predetermined number of prioritized categories to a queue of data to be received by the data source; and receiving, at the data source, via a second API, the message comprising the predetermined number of prioritized categories.

Clause 7: The method of any of Clauses 1-6, further including receiving, from the language model, explainability statements associated with respective candidate categories of the generated candidate categories; and sending the explainability statements to the data source.

Clause 8: A method including: receiving, from a data source, untagged data; extracting, from the untagged data, text features; generating a first prompt based on the extracted text features and a list of categories, wherein the first prompt is configured to cause the language model to select one or more candidate categories from the list of categories; sending, to a language model, the first prompt, the extracted text features, and the list of categories; receiving, from the language model, the candidate categories selected from the list of categories for tagging the received untagged data; generating a second prompt based on the candidate categories; sending, to the language model, the second prompt; receiving, from the language model a predetermined number of prioritized categories; and sending, to the data source, the predetermined number of prioritized categories from the list of categories for tagging the received untagged data.

Clause 9: The method of Clause 8, wherein the list of categories is derived from a knowledge graph associated with a domain of the data source.

Clause 10: The method of Clause 11, further including requesting, via an application programming Interface (API), to add a job to an inbound message queue, wherein the job comprises generating the selected categories for the received untagged data; and sending, from an inbound service bus comprising the inbound message queue, the job to a job processing layer.

Clause 11: The method of any of Clauses 8-10, wherein the first prompt and the second prompt are sent to the language model via an application programming interface.

Clause 13: The method of any of Clauses 8-11, further including detecting, within the predetermined number of prioritized categories, one or more extraneous categories by cross-referencing the predetermined number of prioritized categories with the list of categories; and removing the one or more extraneous categories from the predetermined number of prioritized categories.

Clause 14: The method of any of Clauses 8-12, further including receiving, from the language model explainability statements associated with respective candidate categories of the generated candidate categories; and sending the explainability statements to the data source.

Clause 15: A processing system, comprising means for performing a method in accordance with any one of Clauses 1-14.

Clause 16: A non-transitory computer-readable medium comprising computer-executable instructions that, when executed by one or more processors of a processing system, cause the processing system to perform a method in accordance with any one of Clauses 1-14.

Clause 17: A computer program product embodied on a computer-readable storage medium comprising code for performing a method in accordance with any one of Clauses 1-14.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method, comprising:
receiving, from a data source, untagged data;
extracting, from the untagged data, text features comprising a job title and job responsibilities;
generating a first prompt based on the extracted text features and a list of categories, wherein the first prompt is configured to cause a language model to select one or more candidate categories from the list of categories;
sending, to the language model, the first prompt, the job title, and the job responsibilities;
receiving, from the language model, the one or more candidate categories selected from the list of categories for tagging the received untagged data;
generating a second prompt, wherein the second prompt is configured to cause the language model to select a predetermined number of prioritized categories from the one or more candidate categories;
sending, to the language model, the second prompt;
receiving, from the language model, the predetermined number of prioritized categories;
sending, to the data source, the predetermined number of prioritized categories from the list of categories for tagging the received-untagged data; and
sending to an application, the predetermined number of prioritized categories for review by a user, wherein the predetermined number of prioritized categories are selectable within the application to tag the untagged data.

2. The method of claim 1, wherein the list of categories is derived from a knowledge graph associated with a domain of the data source.

3. The method of claim 1, further comprising:
requesting, via an application programming interface (API), to add a job to an inbound message queue, wherein the job comprises generating the selected categories for the received untagged data; and
sending, from an inbound service bus comprising the inbound message queue, the job to a job processing layer.

4. The method of claim 1, wherein the first prompt and the second prompt are sent to the language model via an application programming interface.

5. The method of claim 1, further comprising:
detecting, within the predetermined number of prioritized categories, one or more extraneous categories by cross-referencing the predetermined number of prioritized categories with the list of categories; and
removing the one or more extraneous categories from the predetermined number of prioritized categories.

6. The method of claim 1, wherein sending, to the data source, the predetermined number of prioritized categories from the list of categories for tagging the received untagged data further comprises:
sending, to an inbound message queue, the predetermined number of prioritized categories;
sending, via a first application programming interface (API), a request to add a message comprising the predetermined number of prioritized categories to a queue of data to be received by the data source; and
receiving, at the data source, via a second API, the message comprising the predetermined number of prioritized categories.

7. The method of claim 1, further comprising:
receiving, from the language model, explainability statements associated with respective candidate categories of the one or more candidate categories; and
sending the explainability statements to the data source.

8. A processing system, comprising:
one or more memories comprising computer-executable instructions; and
one or more processors configured to execute the computer-executable instructions causing the processing system to:
receive, from a data source, untagged data;
extract, from the untagged data, text features comprising a job title and job responsibilities:
generate a first prompt based on the extracted text features and a list of categories, wherein the first prompt is configured to cause a language model to select one or more candidate categories from the list of categories;
send, to the language model, the first prompt, the job title, and the job responsibilities;
receive, from the language model, the one or more candidate categories selected from the list of categories for tagging the received-untagged data;
generate a second prompt, wherein the second prompt is configured to cause the language model to select a predetermined number of prioritized categories from the one or more candidate categories;
send, to the language model, the second prompt;
receive, from the language model the predetermined number of prioritized categories;
send, to the data source, the predetermined number of prioritized categories from the list of categories for tagging the untagged data; and
send to an application, the predetermined number of prioritized categories for review by a user, wherein the predetermined number of prioritized categories are selectable within the application to tag the untagged data.

9. The processing system of claim 8, wherein the list of categories is derived from a knowledge graph associated with a domain of the data source.

10. The processing system of claim 8, wherein the one or more processors are further configured to cause the processing system to:
request, via an application programming interface (API), to add a job to an inbound message queue, wherein the job comprises generating the selected categories for the received untagged data; and
send, from an inbound service bus comprising the inbound message queue, the job to a job processing layer.

11. The processing system of claim 8, wherein the first prompt and the second prompt are sent to the language model via an application programming interface.

12. The processing system of claim 11, wherein the one or more processors are further configured to cause the processing system to:
detect, within the predetermined number of prioritized categories, one or more extraneous categories by cross-referencing the predetermined number of prioritized categories with the list of categories; and
remove the one or more extraneous categories from the predetermined number of prioritized categories.

13. The processing system of claim 11, wherein to send, to the data source, the predetermined number of prioritized categories from the list of categories for tagging the received untagged data, the one or more processors are further configured to cause the processing system to:
send, to an inbound message queue, the predetermined number of prioritized categories;
send, via a first application programming interface (API), a request to add a message comprising the predetermined number of prioritized categories to a queue of data to be received by the data source; and
receive, at the data source, via a second API, the message comprising the predetermined number of prioritized categories.

14. The processing system of claim 11, wherein the one or more processors are further configured to cause the processing system to:
receive, from the language model, explainability statements associated with respective candidate categories of the one or more candidate categories; and
send the explainability statements to the data source .

15. A method comprising:
receiving, from a data source, untagged data;
extracting, from the untagged data, text features;
generating a first prompt based on the extracted text features and a list of categories, wherein the first prompt is configured to cause a language model to select one or more candidate categories from the list of categories;
sending, to the language model, the first prompt, the extracted text features, and the list of categories;
receiving, from the language model, the one or more candidate categories selected from the list of categories for tagging the received-untagged data;
generating a second prompt, wherein the second prompt is configured to cause the language model to select a predetermined number of prioritized categories from the one or more candidate categories;
sending, to the language model, the second prompt;
receiving, from the language model the predetermined number of prioritized categories;
sending, to the data source, the predetermined number of prioritized categories from the list of categories for tagging the untagged data and
automatically tagging the untagged data using the predetermined number of prioritized categories.

16. The method of claim 15, wherein the list of categories is derived from a knowledge graph associated with a domain of the data source.

17. The method of claim 15, further comprising:
requesting, via an application programming Interface-interface (API), to add a job to an inbound message queue, wherein the job comprises generating the selected categories for the received untagged data; and
sending, from an inbound service bus comprising the inbound message queue, the job to a job processing layer.

18. The method of claim 15, wherein the first prompt and the second prompt are sent to the language model via an application programming interface.

19. The method of claim 15, further comprising:
detecting, within the predetermined number of prioritized categories, one or more extraneous categories by cross-referencing the predetermined number of prioritized categories with the list of categories; and
removing the one or more extraneous categories from the predetermined number of prioritized categories.

20. The method of claim 15, further comprising:
receiving, from the language model, explainability statements associated with respective candidate categories of the one or more candidate categories; and
sending the explainability statements to the data source.
